(19) United States
(12) Patent Application Publication
(10) Pub. No.: US 2026/0035282 A1
(43) Pub. Date: Feb. 5, 2026

(54) METHOD OF MANUFACTURING A HOLLOW CORE OPTICAL FIBER

(71) Applicant: CORNING INCORPORATED, CORNING, NY (US)

(72) Inventors: Matthew Ryan Drake, Big Flats, NY (US); Seth Griffin, Elmira, NY (US); Ming-Jun Li, Horseheads, NY (US); Joseph Edward McCarthy, Hornell, NY (US)

(21) Appl. No.: 19/278,041

(22) Filed: Jul. 23, 2025

Related U.S. Application Data
(60) Provisional application No. 63/679,026, filed on Aug. 2, 2024.

(51) Int. Cl. C03B 37/012; C03B 37/018; C03B 37/027; G02B 6/032

(52) U.S. Cl. CPC C03B 37/01222; C03B 37/01861; C03B 37/02781; C03B 2203/16; G02B 6/032

(57) ABSTRACT

A method of manufacturing a hollow core optical fiber including (a) a consolidated tube presenting step including presenting a consolidated cladding tube including a consolidated cladding first end, a consolidated cladding second end, a consolidated cladding longitudinal axis, and a consolidated cladding inner surface, the consolidated cladding inner surface defining a consolidated cladding interior and including consolidated cladding recesses (i) positioned around the consolidated cladding longitudinal axis and (ii) extending from the consolidated first end to the consolidated second end; and (b) a capillary tube coupling step comprising coupling preform capillary tubes to the consolidated cladding inner surface within the consolidated cladding recesses thus creating an optical fiber preform, each of the preform capillary tubes disposed within a different one of the consolidated cladding recesses.

This Application claims the benefit of priority to U.S. Provisional Patent Application Ser. No. 63/679,026 filed on Aug. 2, 2024, the content of which is relied upon and incorporated herein by reference in its entirety.

### TECHNICAL FIELD

The present disclosure pertains to methods of manufacturing a hollow core optical fiber and, in particular, hollow core optical fibers with a recessed cladding and capillaries disposed within the recesses of the cladding.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance occurs when electromagnetic radiation within any of the anti-resonant cladding elements destructively interferes with itself, resulting in minimum transmission of optical power through the glass of the anti-resonant element. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges are an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, if anti-resonant cladding elements are designed not to contact each other but do as a result of manufacturing imprecision, the anti-resonant hollow core optical fiber exhibits peaks in confinement loss as a function of wavelength. Further, inaccuracies in the azimuthal position of the anti-resonant cladding elements relative to each other impact the confinement loss. Furthermore, it is difficult to manufacture the anti-resonant hollow core optical fiber where the anti-resonant cladding elements do not make contact and/or where the anti-resonant cladding elements are drawn in their as-designed azimuthal position.

### SUMMARY

The present disclosure addresses those problems, among others, with methods of making a hollow core optical fiber with a fiber cladding tube with a fiber cladding surface having fiber cladding recesses within which fiber primary capillaries are disposed. The fiber cladding recesses help maintain the fiber primary capillaries within the fiber cladding tube at their as-designed positions.

According to a first aspect of the present disclosure, a method of manufacturing a hollow core optical fiber, the method comprises: (1) a consolidated workpiece presenting step comprising presenting a consolidated workpiece comprising (a) a consolidation bait rod comprising: a consolidation rod first end, a consolidation rod second end, a consolidation rod longitudinal axis, and a consolidation rod outer surface at a consolidation rod outer radius that varies azimuthally around the consolidation rod longitudinal axis and (b) a consolidated cladding tube disposed on the consolidation rod outer surface azimuthally around the consolidation rod longitudinal axis, the consolidated cladding tube comprising a consolidated cladding first end near the consolidation rod first end, a consolidated cladding second end near the consolidation rod second end, a consolidated cladding longitudinal axis, and a consolidated cladding inner surface, the consolidated cladding inner surface forming a consolidated cladding interior and comprising consolidated cladding recesses (i) positioned azimuthally around the consolidated cladding longitudinal axis and (ii) extending from the consolidated cladding first end to the consolidated cladding second end; and (2) a bait rod removing step comprising removing the consolidation bait rod from the consolidated cladding interior.

According to a second aspect of the present disclosure, the method of the first aspect is presented, wherein the consolidation rod outer surface comprises (i) constant portions where the consolidation rod outer radius is constant as a function of azimuthal position around the consolidation rod longitudinal axis and (ii) variable portions where the consolidation rod outer radius varies as a function of position around the consolidation rod longitudinal axis.

According to a third aspect of the present disclosure, the method of the second aspect is presented, wherein the consolidation rod outer surface alternates between the constant portions and the variable portions azimuthally around the consolidation rod longitudinal axis.

According to a fourth aspect of the present disclosure, the method of any one of the second through third aspects is presented, wherein the variable portions extend radially outward from the constant portions relative to the consolidation rod longitudinal axis.

According to a fifth aspect of the present disclosure, the method of any one of the second through fourth aspects is presented, wherein the variable portions are partially circular or partially elliptical.

According to a sixth aspect of the present disclosure, the method of any one of the first through fifth aspects is presented, wherein the consolidation bait rod comprises graphite, alumina, or zirconia.

According to a seventh aspect of the present disclosure, the method of any one of the first through sixth aspects further comprises: a capillary tube coupling step, occurring after the bait rod removing step, comprising coupling preform capillary tubes to the consolidated cladding inner surface within the consolidated cladding recesses thus creating an optical fiber preform, each of the preform capillary tubes disposed within a different one of the consolidated cladding recesses.

According to an eighth aspect of the present disclosure, the method of the seventh aspect further comprises a drawing step comprising drawing a hollow core optical fiber from the optical fiber preform.

According to a ninth aspect of the present disclosure, the method of any one of the first through eighth aspects further comprises: a direct soot consolidating step, occurring before the consolidated workpiece presenting step, comprising consolidating a soot cladding tube that is disposed azimuthally around the consolidation rod outer surface of the consolidation bait rod to form the consolidated workpiece, the soot cladding tube comprising a soot cladding first end near the consolidation rod first end, a soot cladding second end near the second consolidation rod end, and a soot cladding inner surface defining a soot cladding interior through which the consolidation rod longitudinal axis extends.

According to a tenth aspect of the present disclosure, the method of the ninth aspect is presented, wherein the soot cladding inner surface contacts the consolidation rod outer surface entirely azimuthally around the consolidation rod longitudinal axis before the direct soot consolidating step.

According to an eleventh aspect of the present disclosure, the method of the tenth aspect further comprises a direct soot depositing step, occurring before the direct soot consolidating step, comprising depositing silica soot onto the consolidation rod outer surface of the consolidation bait rod to form a soot and bait rod workpiece.

According to a twelfth aspect of the present disclosure, the method of any one of the ninth through tenth aspects is presented, wherein the soot cladding inner surface is separated from the consolidation rod outer surface by air gaps arranged azimuthally around the consolidation rod longitudinal axis before the direct soot consolidating step.

According to a thirteenth aspect of the present disclosure, the method of the twelfth aspect is presented, wherein the soot cladding inner surface is cylindrical.

According to a fourteenth aspect of the present disclosure, the method of any one of the twelfth through thirteenth aspects further comprises: (a) an indirect soot depositing step comprising depositing silica soot onto a deposition rod outer surface of a deposition bait rod to form the soot cladding tube, the deposition bait rod further comprising a deposition rod longitudinal axis, the deposition rod outer surface at a deposition rod outer radius from the deposition rod longitudinal axis that is constant azimuthally around the deposition rod longitudinal axis; (b) a deposition rod removing step comprising removing the deposition bait rod from the soot cladding interior; and (c) a bait rod insertion step comprising inserting the consolidation bait rod into the soot cladding interior, wherein, the indirect soot depositing step, the deposition rod removing step, and the bait rod insertion step occur before the direct soot consolidating step.

According to a fifteenth aspect of the present disclosure, the method of any one of the first through eighth aspects further comprises: (a) an indirect soot depositing step comprising depositing silica soot onto a deposition rod outer surface of a deposition bait rod to form a soot cladding tube, the deposition bait rod further comprising a deposition rod longitudinal axis, the deposition rod outer surface at a deposition rod outer radius from the deposition rod longitudinal axis that is constant azimuthally around the deposition rod longitudinal axis; (b) an indirect soot consolidating step comprising consolidating the soot cladding tube around the deposition rod outer surface to form the consolidated cladding tube; (c) a deposition rod removing step comprising removing the deposition bait rod from the consolidated cladding interior; (d) a reflow rod insertion step comprising inserting the consolidation bait rod into the consolidated cladding interior; and (e) a reflowing step comprising thermally treating the consolidated cladding tube with the consolidation bait rod therein so that the consolidated cladding tube flows to conform the consolidated cladding inner surface around the consolidation rod outer surface, thus forming the consolidated workpiece.

According to a sixteenth aspect of the present disclosure, a method of manufacturing a hollow core optical fiber, the method comprises (a) a consolidated tube presenting step comprising presenting a consolidated cladding tube comprising a consolidated cladding first end, a consolidated cladding second end, a consolidated cladding longitudinal axis, and a consolidated cladding inner surface, the consolidated cladding inner surface defining a consolidated cladding interior and comprising consolidated cladding recesses (i) positioned around the consolidated cladding longitudinal axis and (ii) extending from the consolidated first end to the consolidated second end; and (b) a capillary tube coupling step comprising coupling preform capillary tubes to the consolidated cladding inner surface within the consolidated cladding recesses thus creating an optical fiber preform, each of the preform capillary tubes disposed within a different one of the consolidated cladding recesses.

According to a seventeenth aspect of the present disclosure, the method of the sixteenth aspect further comprises a drawing step comprising drawing a hollow core optical fiber from the optical fiber preform.

According to an eighteenth aspect of the present disclosure, the method of any one of the sixteenth through seventeenth aspects further comprises: a recessed soot cladding consolidating step comprising consolidating a recessed soot cladding tube to form the consolidated cladding tube, the recessed soot cladding tube comprising: a recessed soot cladding first end, a recessed soot cladding second end, a recessed soot cladding longitudinal axis, and a recessed soot cladding inner surface, the recessed soot cladding inner surface defining a recessed soot cladding interior and comprising recessed soot cladding recesses (i) positioned around the recessed soot cladding longitudinal axis and (ii) extending from the recessed soot cladding first end to the recessed soot cladding second end.

According to a nineteenth aspect of the present disclosure, the method of the eighteenth aspect further comprises a soot recess machining step comprising machining soot cladding recesses into a soot blank tube to form the recessed soot cladding tube, the soot blank tube comprising a soot blank first end, a soot blank second end, a soot blank longitudinal axis, and a soot blank inner surface that is cylindrical and at a soot blank inner radius from the soot blank longitudinal axis that is smaller than the recessed soot cladding inner radius of the recessed soot cladding tube.

According to a twentieth aspect of the present disclosure, the method of the nineteenth aspect is presented, wherein the soot recess machining step includes drilling holes into the soot blank to remove the silica soot necessary to form the soot cladding recesses.

According to a twenty-first aspect of the present disclosure, the method of any one of the sixteenth through seventeenth aspect further comprises: (a) a soot blank forming step comprising vapor depositing silica soot on a deposition bait rod to form a soot blank tube; (b) a soot blank consolidating step comprising consolidating the soot blank tube to form a consolidated blank tube comprising (i) a consolidated blank longitudinal axis and (ii) a consolidated blank outer surface at a consolidated blank outer radius from the consolidated blank longitudinal axis that is substantially constant azimuthally around the consolidated blank longitudinal axis; and (c) a consolidated recess machining step comprising machining the consolidated cladding recesses into the consolidated blank tube to form the consolidated cladding tube.

According to a twenty-second aspect of the present disclosure, the method of any one of the sixteenth through seventeenth aspect further comprises: an extruding step comprising extruding molten or softened glass with an extrusion die to form the consolidated cladding tube.

According to a twenty-third aspect of the present disclosure, the method of the twenty-second aspect is presented, wherein (a) the extrusion die comprises (i) an outer extrusion aperture that is at an outer extrusion radius from an extrusion longitudinal axis and (ii) an inner extrusion rod through which the extrusion longitudinal axis extends, the inner extrusion rod comprising an extrusion rod outer surface at an extrusion rod outer radius that varies azimuthally around the extrusion longitudinal axis, and (b) during the extruding of the molten or softened glass, (i) the molten or softened glass and the inner extrusion rod are pushed through the outer extrusion aperture, with the molten or softened glass disposed radially between the inner extrusion rod and the outer extrusion aperture relative to the extrusion longitudinal axis and (ii) the inner extrusion rod is retracted back through the outer extrusion aperture leaving the workpiece.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of a hollow core optical fiber, illustrating a fiber cladding tube and fiber primary capillaries disposed therein;

FIG. 2 is an elevational view of a cross-section of the hollow core optical fiber of FIG. 1 taken through line II-II with the fiber primary capillaries not illustrated to show details of the fiber cladding tube, such as a fiber cladding inner surface at a fiber cladding inner radius that varies azimuthally around a fiber longitudinal axis and forming fiber cladding recesses;

FIG. 3 is an elevational view of a cross-section of the hollow core optical fiber of FIG. 1 taken through line III-III this time showing the fiber primary capillaries partially disposed within the fiber cladding recesses;

FIG. 4 is a schematic flow chart of various embodiments of a first method of manufacturing a hollow core optical fiber;

FIG. 5 is a schematic diagram of a consolidated workpiece presenting step and a bait rod removing step of the first method;

FIG. 6 is an elevational view of a cross-section of a consolidated workpiece subjected to the consolidated workpiece presenting step and a bait rod removing step of the first method taken through line VI-VI of FIG. 5, illustrating the consolidated workpiece including a consolidated cladding tube conforming to a consolidation bait rod with variable portions and constant portions;

FIG. 7 is an elevational view of a cross-section of (i) the consolidated cladding tube taken through line VII-VII of FIG. 5, illustrating consolidated cladding recesses facing a consolidated cladding interior, and (ii) after a capillary tube coupling step of the first method, an optical fiber preform that includes preform capillary tubes disposed within the consolidated cladding recesses of the consolidated cladding tube;

FIG. 8 is an elevational view of the optical fiber preform;

FIG. 9 is a schematic diagram of a drawing step of the first method, illustrating the hollow core optical fiber being drawn from the optical fiber preform;

FIG. 10 is a schematic illustration of a direct soot consolidating step of the first method, illustrating a soot and bait rod workpiece, which includes a soot cladding tube disposed on the consolidation bait rod, disposed within a consolidation furnace;

FIG. 11 is a cross-sectional view of the soot and bait rod workpiece taken through line X-X of FIG. 10, illustrating the soot cladding tube including a soot cladding inner surface conforming to a consolidation rod outer surface of the consolidation bait rod;

FIG. 12 is a cross-sectional view of the soot cladding tube;

FIG. 13 is a schematic diagram of a direct soot depositing step of the first method, illustrating silica soot being deposited on the consolidation rod outer surface of the consolidation bait rod to form the soot and bait rod workpiece;

FIG. 14 is a cross-sectional view of another embodiment of the soot and bait rod workpiece, illustrating air gaps separating the soot cladding inner surface of the soot cladding tube from the consolidation rod outer surface of the consolidation bait rod;

FIG. 15 is a schematic diagram of an indirect soot depositing step of the first method where silica soot is deposited on the deposition bait rod to form the soot cladding tube, a deposition bait rod removal step where the deposition bait rod is removed from the soot cladding tube, and a bait rod insertion step where the consolidation bait rod is inserted into a soot cladding interior of the soot cladding tube to form the soot and bait rod workpiece;

FIG. 16 is a schematic diagram of the indirect soot depositing step of the first method, an indirect soot consolidating step where the soot cladding tube is consolidated while on the deposition bait rod to form the consolidated cladding tube (but without consolidated cladding recesses) on the deposition bait rod, a deposition bait rod removing step where the deposition bait rod is removed from the consolidated cladding tube, a reflow rod insertion step where the consolidation bait rod is inserted into the consolidated cladding tube, and a reflowing step where the consolidated cladding tube is thermally treated to conform to the consolidated cladding tube and thereby form the consolidated workpiece;

FIG. 17 is a schematic flow chart of a second method of manufacturing the hollow core optical fiber;

FIG. 18 is a schematic diagram of a recessed soot cladding consolidation step of the second method, illustrating a recessed soot cladding tube being thermally treated in a consolidation furnace to form the consolidated cladding tube;

FIG. 19 is a cross-sectional view of the recessed soot cladding tube of FIG. 18, illustrating a recessed soot cladding inner surface with recessed soot cladding recesses;

FIG. 20 is a schematic diagram of a soot recess machining step of the second method, illustrating a drill bit to remove material from a soot blank tube;

FIG. 21 is a cross-sectional view of the soot blank tube of FIG. 20;

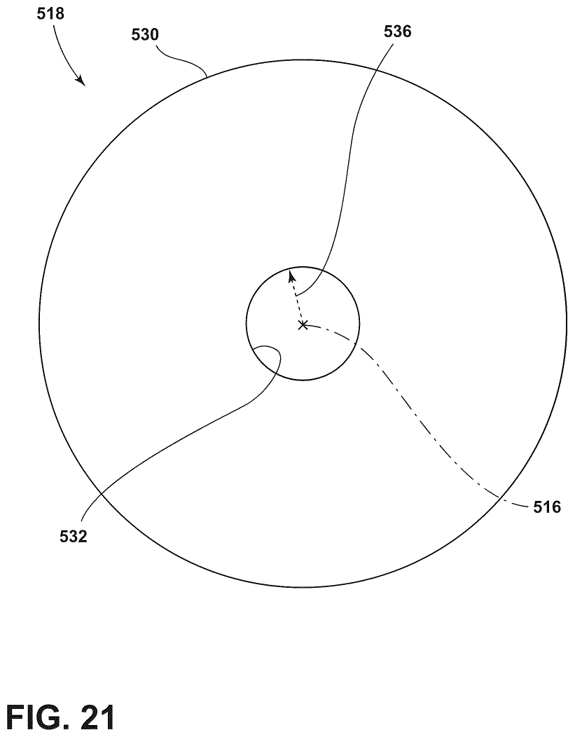

FIG. 22 is a schematic diagram of a soot blank consolidating step of the second method, illustrating the soot blank tube being consolidated within the consolidating furnace to form a consolidated blank tube;

FIG. 23 is a schematic flow chart of an extruding step of the second method, illustrating an extrusion die extruding molten or softened glass to form the consolidated cladding tube; and

FIG. 24 is an elevational view of the extrusion die, illustrating an inner extrusion rod through which an extrusion longitudinal axis extends and an outer extrusion aperture through which the extrusion longitudinal axis extends radially outward of the inner extrusion rod.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

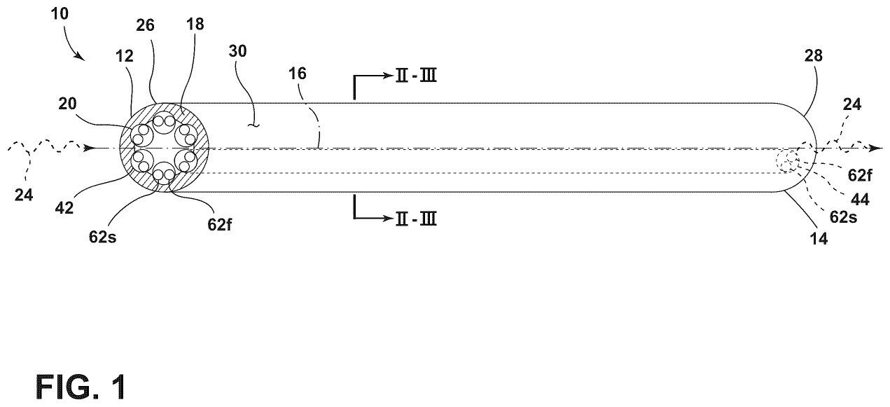

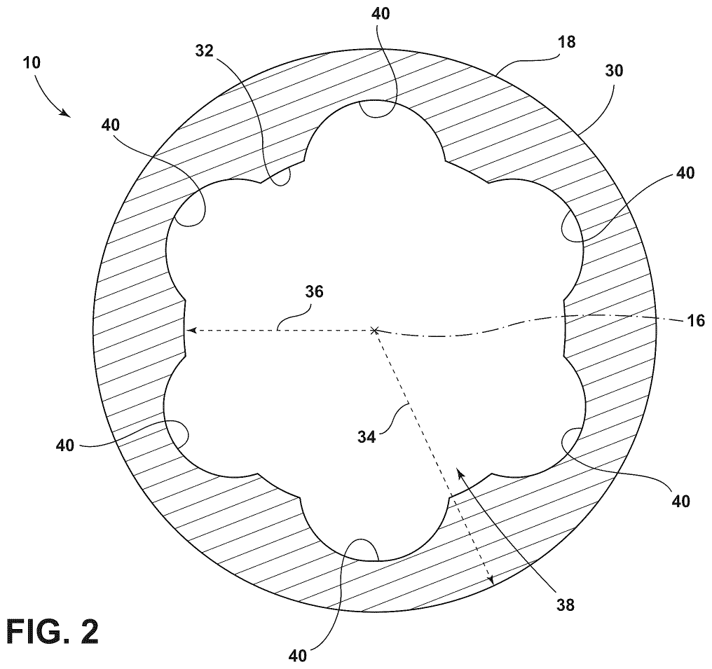

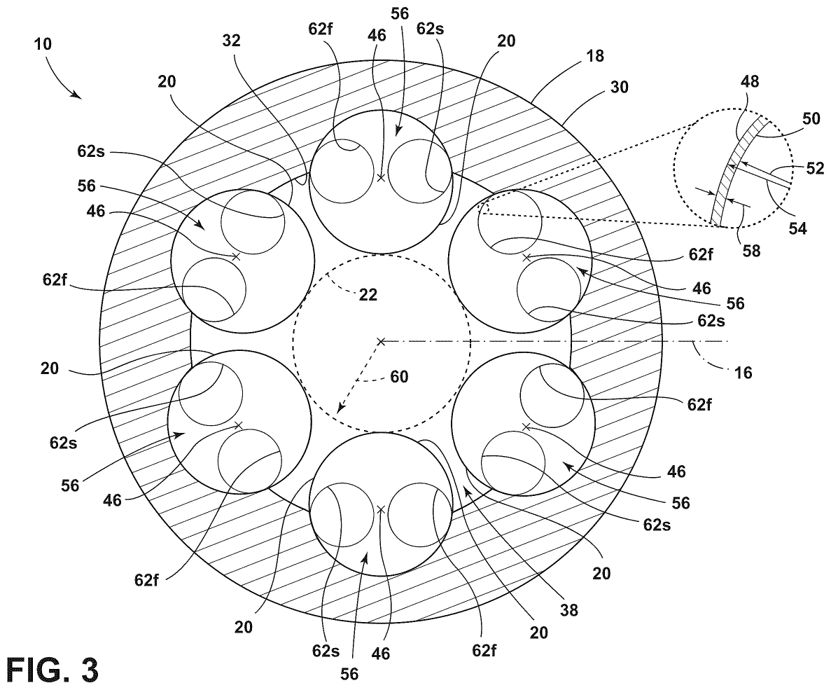

Before discussing various manufacturing processes, a hollow core optical fiber 10 can first be discussed to provide a foundation for what follows. Referring to FIGS. 1-3, the hollow core optical fiber 10 includes a fiber first end 12, a fiber second end 14, a fiber longitudinal axis 16, a fiber cladding tube 18, fiber primary capillaries 20, and a fiber effective core region 22. The fiber longitudinal axis 16 extends from the fiber first end 12 to the fiber second end 14. In use, electromagnetic radiation 24 enters into the fiber first end 12, transmits predominantly within the fiber effective core region 22, and exits the fiber second end 14.

The fiber cladding tube 18 likewise extends, azimuthally around the fiber longitudinal axis 16, from the fiber first end 12 to the fiber second end 14. The fiber cladding tube 18 includes a fiber cladding first end 26 and a fiber cladding second end 28. The fiber cladding first end 26 is proximate, and may at least partially define, the fiber first end 12. The fiber cladding second end 28 is proximate, and may at least partially define, the fiber second end 14.

The fiber cladding tube 18 further includes a fiber cladding outer surface 30 and a fiber cladding inner surface 32. The fiber cladding outer surface 30 is at a fiber cladding outer radius 34 from the fiber longitudinal axis 16. The fiber cladding inner surface 32 is at a fiber cladding inner radius 36 from the fiber longitudinal axis 16. The fiber cladding inner surface 32 defines a fiber cladding interior 38. The fiber cladding inner radius 36 varies as a function of azimuthal position around the fiber longitudinal axis 16. The fiber cladding inner surface 32 thus defines fiber cladding recesses 40.

The fiber primary capillaries 20 are disposed within the fiber cladding interior 38. The fiber primary capillaries 20 are arranged azimuthally around the fiber longitudinal axis 16. Each of the fiber primary capillaries 20 includes a fiber capillary first end 42 and a fiber capillary second end 44. The fiber capillary first end 42 is proximate, and may at least partially define, the fiber first end 12. The fiber capillary second end 44 is proximate, and may at least partially define, the fiber second end 14.

Each of the fiber primary capillaries 20 further includes a fiber primary capillary longitudinal axis 46 that is parallel to the fiber longitudinal axis 16. In addition, each of the fiber primary capillaries 20 further includes a fiber primary capillary outer surface 48 and a fiber primary capillary inner surface 50. The fiber primary capillary outer surface 48 is at a fiber primary capillary outer radius 52 from the fiber primary capillary longitudinal axis 46. The fiber primary capillary inner surface 50 is at a fiber primary capillary inner radius 54 from the fiber primary capillary longitudinal axis 46. The fiber primary capillary inner surface 50 defines a fiber primary capillary interior 56. In embodiments, the fiber primary capillary outer radius 52 is within a range of from 5 μm to 30 μm. For example, the fiber primary capillary outer radius 52 can be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or within any range bound by any two of those values (e.g., from 25 μm to 29 μm, from 18 μm to 24 μm, from 10 μm to 25 μm, from 12 μm to 20 μm, and so on). The fiber primary capillary outer radius 52 can be less than 18 μm or greater than 30 μm.

Each of the fiber primary capillaries 20 further includes a fiber primary capillary thickness 58. The fiber primary capillary thickness 58 is the distance measured radially from the fiber primary capillary longitudinal axis 46 between the fiber primary capillary inner surface 50 and the fiber primary capillary outer surface 48. In embodiments, the fiber primary capillary thickness 58 is within a range of from 250 nm to 1500 nm. For example, the fiber primary capillary thickness 58 is 250 nm, 300 nm, 350 nm, 400 nm, 450 nm, 500 nm, 550 nm, 600 nm, 650 nm, 700 nm, 750nm, 800 nm, 850 nm, 900 nm, 950 nm, 1000 nm, 1050 nm, 1100 nm, 1150 nm, 1200 nm, 1250nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the fiber primary capillary thickness 58 is within ±30%, ±25%, ±20%, ±15%, ±10%, or ±5% of a calculated thickness/as defined by the equation:

$$t = \frac{( 2 m - 1 ) λ}{4 \sqrt{{n}^{2} - 1}}$$

where t is the calculated thickness, m is an integer (e.g., 1, 2, 3, . . . ) corresponding to the order of antiresonance, λ is the operating wavelength, and n is the refractive index of the fiber primary capillaries 20 at the operating wavelength λ.

Each of the fiber primary capillaries 20 is disposed within a different one of the fiber cladding recesses 40. Each of the fiber primary capillaries 20 contacts the fiber cladding inner surface 32 and can be fused thereto. In some instances, each of the fiber primary capillaries 20 contacts or merges with adjacent fiber primary capillaries 20 in both azimuthal directions around the fiber longitudinal axis 16. In other instances, each of the fiber primary capillaries 20 is separated from adjacent fiber primary capillaries 20 in both azimuthal directions around the fiber longitudinal axis 16.

The hollow core optical fiber 10 can have any number of fiber primary capillaries 20. In embodiments, the fiber cladding tube 18 has a quantity of fiber cladding recesses 40 that is equal to the number of the fiber primary capillaries 20. In embodiments, the fiber cladding tube 18 has from 3 to 9 fiber cladding recesses 40. For example, the fiber cladding tube 18 can have 3, 4, 5, 6, 7, 8, or 9 fiber cladding recesses 40. The fiber cladding tube 18 could have less than 3 or greater than 9 fiber cladding recesses 40. The hollow core optical fiber 10 can include from 3 to 9 fiber primary capillaries 20. For example, the hollow core fiber can have 3, 4, 5, 6, 7, 8, or 9 fiber primary capillaries 20. The hollow core optical fiber 10 could have less than 3 or greater than 9 fiber primary capillaries 20.

The fiber effective core region 22 is within the fiber cladding interior 38. The fiber effective core region 22 is tangential to the fiber primary capillary outer surface 48 of each of the fiber primary capillaries 20. The fiber effective core region 22 is at a fiber core radius 60 from the fiber longitudinal axis 16. The fiber effective core region 22 extends between the fiber first end 12 and the fiber second end 14. The fiber primary capillaries 20 are disposed radially outward of the fiber effective core region 22. In embodiments, the fiber core radius 60 is within a range of from 5 μm to 100 μm. For example, the fiber core radius 60 can be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, or within any range bound by any two of those values (e.g., from 11 μm to 18 μm, from 14 μm to 17 μm, from 45 μm to 75 μm, from 50 μm to 95 μm, and so on).

The hollow core optical fiber 10 can further include fiber nested capillaries 62 that are nested within the fiber primary capillaries 20. As illustrated, the fiber nested capillaries 62 can include fiber first nested capillaries 62f and fiber second nested capillaries 62s. Each of the fiber first nested capillaries 62f and each of the fiber second nested capillaries 62s can be nested as pairs in a different one of the fiber primary capillaries 20. The hollow core optical fiber 10 can be an anti-resonant hollow core optical fiber 10.

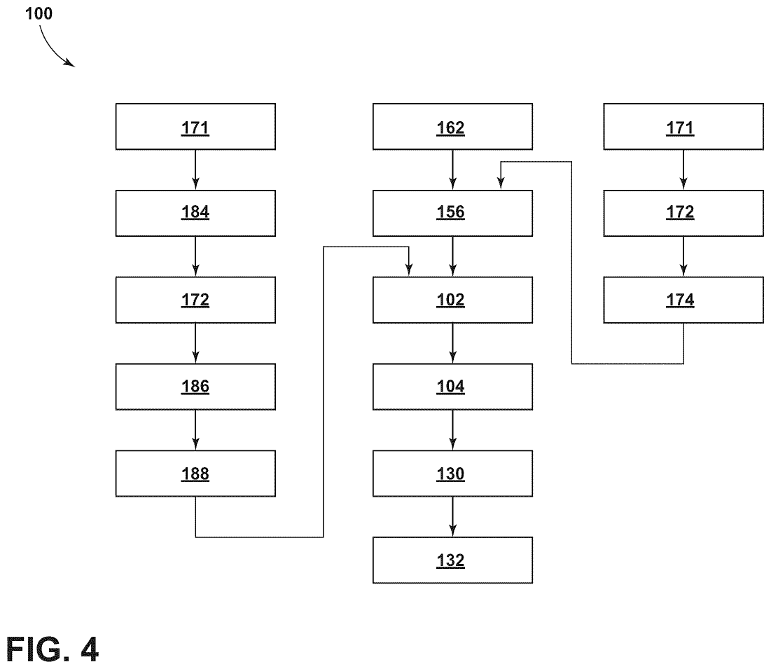

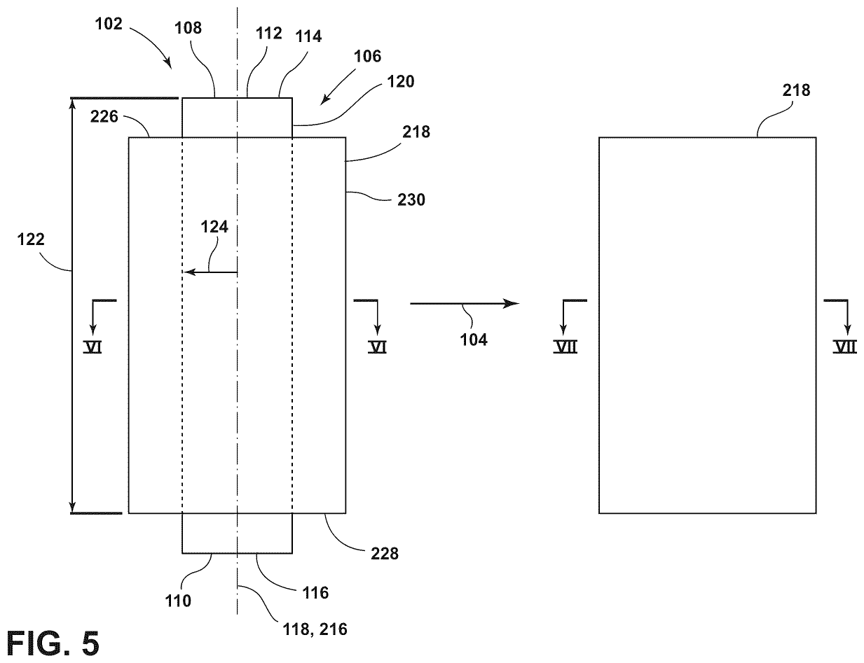

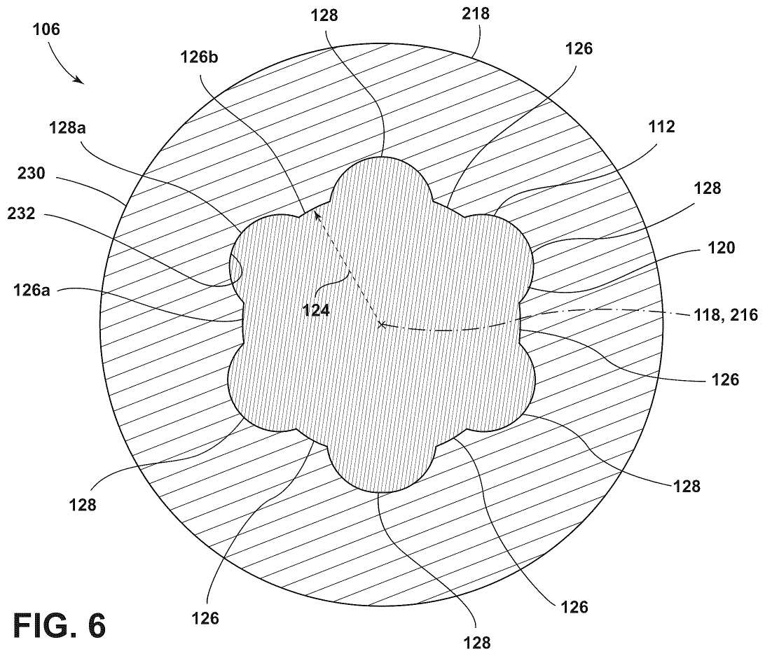

Referring now to FIGS. 4-7, a first method 100 of manufacturing the hollow core optical fiber 10 includes a consolidated workpiece presenting step 102 and a bait rod removing step 104.

The consolidated workpiece presenting step 102 includes presenting a consolidated workpiece 106. The consolidated workpiece 106 includes a consolidated workpiece first end 108, a consolidated workpiece second end 110, a consolidation bait rod 112, and a consolidated cladding tube 218. As will become apparent, the consolidated cladding tube 218 is analogous to the fiber cladding tube 18 of the hollow core optical fiber 10 and thus the like numbering. The consolidated workpiece first end 108 and the consolidated workpiece second end 110 face in opposite directions. The consolidated cladding tube 218 is disposed around the consolidation bait rod 112, as further explained. The consolidation bait rod 112 is removable from the consolidated cladding tube 218.

The consolidation bait rod 112 includes a consolidation rod first end 114, a consolidation rod second end 116, a consolidation rod longitudinal axis 118, and a consolidation rod outer surface 120. The consolidation rod first end 114 defines at least in part the consolidated workpiece first end 108. The consolidation rod second end 116 defines at least in part the consolidated workpiece second end 110. The consolidation rod longitudinal axis 118 extends through the consolidation rod first end 114 and the consolidation rod second end 116. The consolidation bait rod 112 has a consolidation rod length 122 between the consolidation rod first end 114 and the consolidation rod second end 116. In embodiments, the consolidation rod length 122 is within a range of from 0.5 m to 2.0 m. For example, the consolidation rod length 122 can be 0.5 m, 0.6 m, 0.7 m, 0.8 m, 0.9 m, 1.0 m, 1.1 m, 1.2 m, 1.3 m, 1.4 m, 1.5 m, 1.6 m, 1.7 m, 1.8 m, 1.9 m, 2.0 m, or within any range bound by any two of those values (e.g., from 0.7 m to 1.1 m, from 1.6 m to 1.9 m, and so on). The length can be less than 0.5 m or greater than 2.0 m.

The consolidation rod outer surface 120 is at a consolidation rod outer radius 124 from the consolidation rod longitudinal axis 118. The consolidation rod outer radius 124 varies azimuthally around the consolidation rod longitudinal axis 118. In embodiments, the consolidation rod outer surface 120 includes constant portions 126 and variable portions 128. At the constant portions 126, the consolidation rod outer radius 124 is constant as a function of azimuthal position around the consolidation rod longitudinal axis 118. At the variable portions 128, the consolidation rod outer radius 124 varies as a function of position around the consolidation rod longitudinal axis 118. The consolidation rod outer surface 120 can alternate between the constant portions 126 and the variable portions 128 azimuthally around the consolidation rod longitudinal axis 118. For example, moving azimuthally around the consolidation rod longitudinal axis 118, the consolidation rod outer surface 120 includes the constant portion 126a, then the variable portion 128a, then the constant portion 126b, and so on. As illustrated, the variable portions 128 can extend radially outward from the constant portions 126 relative to the consolidation rod longitudinal axis 118. Although the variable portions 128 can take any shape, in some instances the variable portions 128 are partially circular or partially elliptical. By partially circular, it is meant that, when the consolidation bait rod 112 is cross-sectioned orthogonally to the consolidation rod longitudinal axis 118, the consolidation rod outer surface 120 at the variable portions 128 forms part of a circle (e.g., a circular segment). Similarly, by partially elliptical, it is meant that, when the consolidation bait rod 112 is cross-sectioned orthogonally to the consolidation rod longitudinal axis 118, the consolidation rod outer surface 120 at the variable portions 128 forms part of an ellipse (e.g., an elliptical segment). The consolidation rod outer radius 124 can have a maximum value that is within a range of from 0.5 cm to 5.0 cm. For example, the maximum value can be 0.5 cm, 1.0 cm, 1.5 cm, 2.0 cm, 2.5 cm, 3.0 cm, 3.5 cm, 4.0 cm, 4.5 cm, 5.0 cm, or within any range bound by any two of those values (e.g., from 3.0 cm to 4.0 cm, from 1.0 cm to 3.0 cm, and so on). The maximum value can be less than 0.5 cm or greater than 5.0 cm.

In embodiments, the consolidation bait rod 112 includes, or is made of, graphite, alumina, or zirconia. For example, the consolidation bait rod 112 can include, or be made of, graphite. The consolidation bait rod 112 can withstand (e.g., without substantial deformation) temperatures utilized to consolidate silica soot.

As mentioned, the consolidated workpiece 106 further includes the consolidated cladding tube 218. The consolidated cladding tube 218 is disposed on the consolidation rod outer surface 120 of the consolidation bait rod 112 azimuthally around the consolidation rod longitudinal axis 118. The consolidated cladding tube 218 includes a consolidated cladding first end 226, a consolidated cladding second end 228, a consolidated cladding outer surface 230, a consolidated cladding inner surface 232, and a consolidated cladding longitudinal axis 216. The consolidated cladding first end 226 is disposed near the consolidation rod first end 114 of the consolidated cladding tube 218. The consolidated cladding first end 226 at least partially defines the consolidated workpiece first end 108. The consolidated cladding second end 228 is disposed near the consolidation rod second end 116. The consolidated cladding second end 228 at least partially defines the consolidated workpiece second end 110.

The consolidated cladding inner surface 232 of the consolidated cladding tube 218 forms a consolidated cladding interior 238, within which the consolidation bait rod 112 is disposed as part of the consolidated workpiece 106. The consolidated cladding inner surface 232 conforms to the consolidation rod outer surface 120 of the consolidation bait rod 112. The consolidation cladding inner surface 232 includes consolidated cladding recesses 240. The consolidated cladding recesses 240 are positioned azimuthally around the consolidated cladding longitudinal axis 216 (and thus the consolidation rod longitudinal axis 118 when part of the consolidated workpiece 106). The consolidated cladding recesses 240 extend longitudinally from the consolidated cladding first end 226 to the consolidated cladding second end 228.

As mentioned, the first method 100 further includes the bait rod removing step 104. The bait rod removing step 104 includes removing the consolidation bait rod 112 from the consolidated cladding interior 238 and thus disassembling the consolidated workpiece 106.

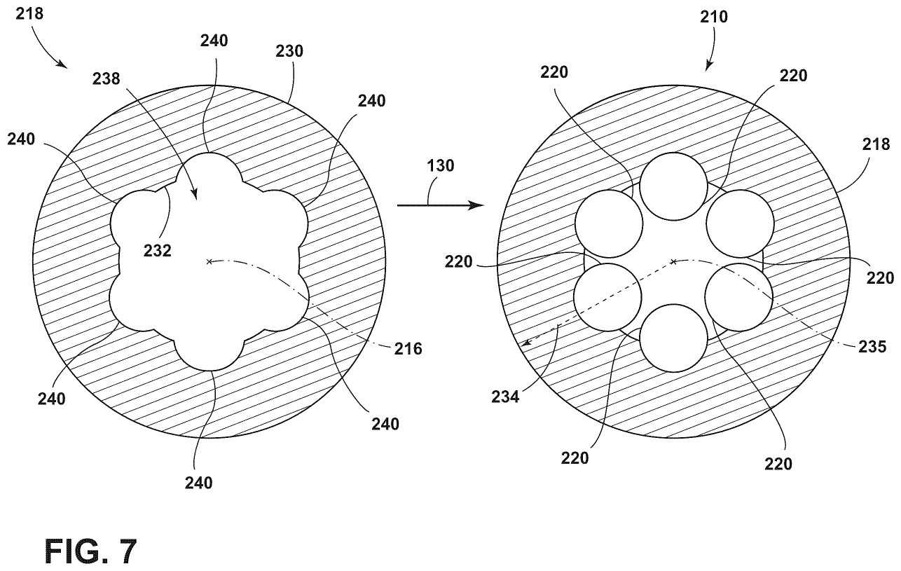

In embodiments, the first method 100 further includes a capillary tube coupling step 130 (see FIG. 7). The capillary tube coupling step 130 occurs after the bait rod removing step 104. The capillary tube coupling step 130 includes coupling preform capillary tubes 220 to the consolidated cladding inner surface 232 of the consolidated cladding tube 218 within the consolidated cladding recesses 240. The preform capillary tubes 220 are analogous to the fiber primary capillaries 20 of the hollow core optical fiber 10 and, thus, the like numbering. Each of the preform capillary tubes 220 is disposed within a different one of the consolidated cladding recesses 240. The preform capillary tubes 220 can be coupled to the consolidated cladding inner surface 232 via flame work or laser heating that fuses the preform capillary tubes 220 thereto, among other options. The coupling of the preform capillary tubes 220 to the consolidated cladding tube 218 forms an optical fiber preform 210.

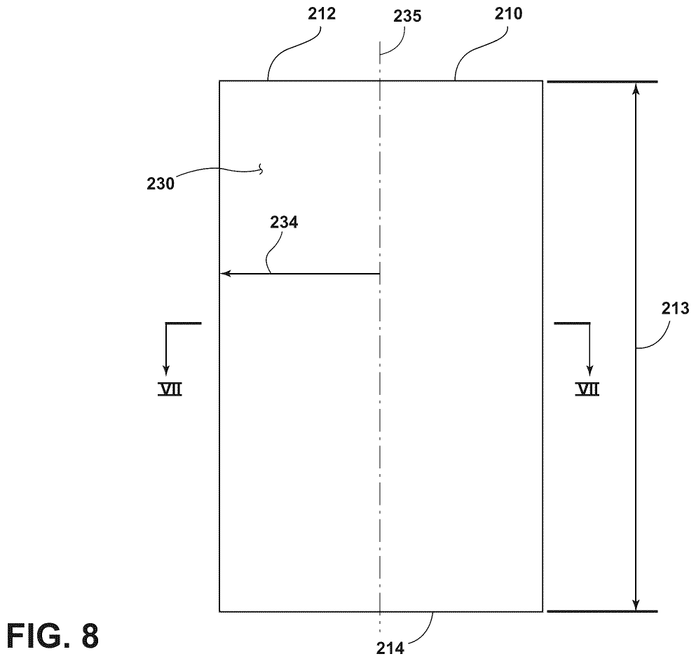

The optical fiber preform 210 is analogous to the hollow core optical fiber 10 and, thus, the like numbering. The optical fiber preform 210 and the hollow core optical fiber 10 differ primarily in the dimensions of the components. More particularly, the consolidated cladding tube 218 becomes the fiber cladding tube 18, the preform capillary tubes 220 become the fiber primary capillaries 20, and so on. The entirety of the discussion above concerning the hollow core optical fiber 10 applies equally as well to the optical fiber preform 210 (except for dimensions) without the need for duplicative drawings and discussion. The optical fiber preform 210 has a preform first end 212 and a preform second end 214 (FIG. 8). The optical fiber preform 210 has a preform length 213 between the preform first end 212 and the preform second end 214. The preform length 213 can be within a range of from 0.3 m to 2.0 m. For example, the preform length 213 can be 0.3 m, 0.4 m, 0.5 m, 0.6 m, 0.7 m, 0.8 m, 0.9 m, 1.0m, 1.1 m, 1.2 m, 1.3 m, 1.4 m, 1.5 m, 1.6 m, 1.7 m, 1.8 m, 1.9 m, 2.0 m, or within any range bound by any two of those values (e.g., from 0.7 m to 1.1 m, from 1.6 m to 1.9 m, and so on). The preform length 213 can be less than 0.3 m or greater than 2.0 m.

The optical fiber preform 210 has a preform outer radius 234 defined by the consolidated cladding outer surface 230. In embodiments, the preform outer radius 234 is within a range of from 1.0 cm to 7.5 cm. For example, the preform outer radius 234 can be 1.0 cm, 1.5 cm, 2.0 cm, 2.5 cm, 3.0 cm, 3.5 cm, 4.0 cm, 4.5 cm, 5.0 cm, 5.5 cm, 6.0 cm, 6.5 cm, 7.0 cm, 7.5 cm, or within any range bound by any two of those values (e.g., from 2.0 cm to 6.0 cm, from 2.5 cm to 5.5 cm, and so on). The preform outer radius 234 can be less than 1.0 cm or greater than 7.5 cm.

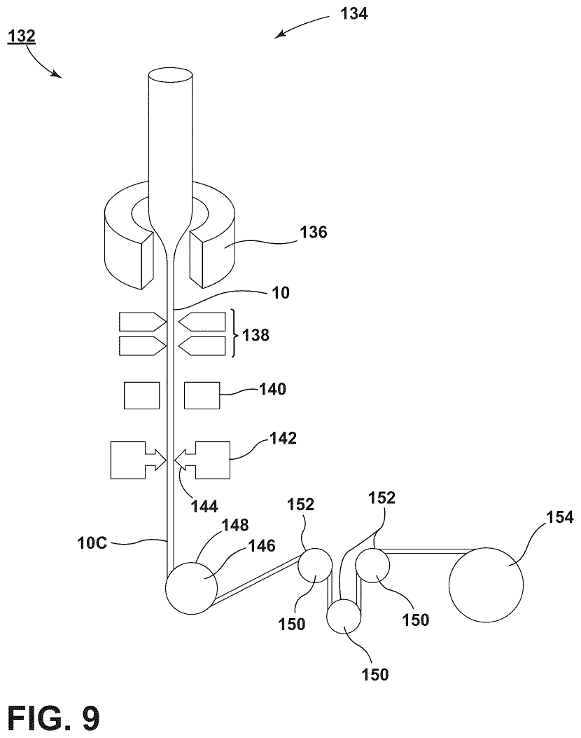

Referring additionally to FIG. 9, in embodiments, the first method 100 further includes a drawing step 132. The drawing step 132 includes drawing a hollow core optical fiber 10 from the optical fiber preform 210. The drawing step 132 can be performed using a draw system 134. The draw system 134 can include a furnace for heating the optical fiber preform 210 to melt or soften the consolidated cladding tube 218 and the preform capillary tubes 220. The furnace can be disposed in a draw tower. In embodiments, the furnace includes a heater 136 such that the optical fiber preform 210 is consumed and drawn into the hollow core optical fiber 10 as it is lowered towards the heater 136. The draw system 134 can further include non-contact measurement sensors 138 for measuring the size (e.g., the fiber cladding outer radius 34) of the hollow core optical fiber 10 that exits the furnace. A cooling station 140 can reside downstream of the measurement sensors 138 and is configured to cool the hollow core optical fiber 10. A coating station 142 can reside downstream of the cooling station 140. The coating station 142 is configured to deposit a protective coating material 144 onto the hollow core optical fiber 10 to form a coated hollow core optical fiber 10C. A tensioner 146 resides downstream of the coating station 142. The tensioner 146 has a surface 148 that pulls (draws) the hollow core optical fiber 10. A set of guide wheels 150 with respective surfaces 152 resides downstream of the tensioner 146. The guide wheels 150 serve to guide the coated hollow core optical fiber 10C to a fiber take-up spool 154 to store the coated hollow core optical fiber 10.

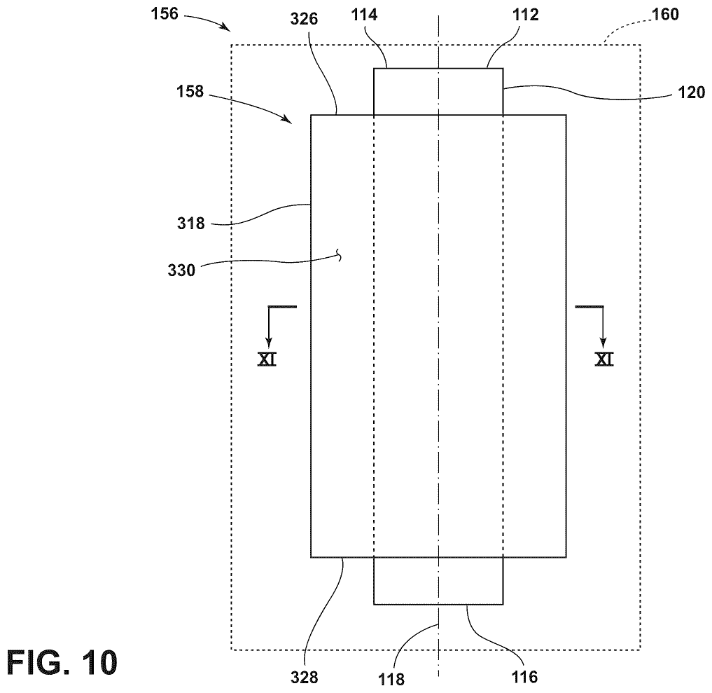

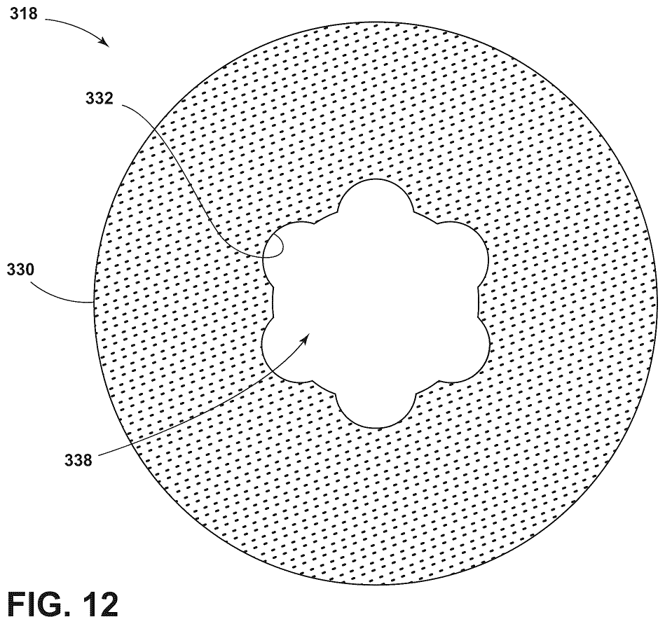

Referring now to FIGS. 10-12, in embodiments, the first method 100 further includes a direct soot consolidating step 156. The direct soot consolidating step 156 occurs before the consolidated workpiece presenting step 102. The soot consolidated step forms the consolidated workpiece 106. The direct soot consolidating step 156 includes consolidating a soot and bait rod workpiece 158. The soot and bait rod workpiece 158 includes a soot cladding tube 318 that is disposed azimuthally around the consolidation rod outer surface 120 of the consolidation bait rod 112. The soot cladding tube 318 is made of silica soot and is a structural precursor to the consolidated cladding tube 218, thus the like numbering. More particularly, the soot cladding tube 318 layer includes a soot cladding first end 326, a soot cladding second end 328, soot cladding outer surface 330, and a soot cladding inner surface 332. The soot cladding first end 326 is disposed near the consolidation rod first end 114. The soot cladding second end 328 is disposed near the consolidation rod second end 116. The soot cladding inner surface 332 faces the consolidation rod outer surface 120. The soot cladding inner surface 332 defines a soot cladding interior 338. The consolidation rod longitudinal axis 118 extends through the soot cladding interior 338. The consolidation bait rod 112 is disposed within the soot cladding interior 338. To consolidate the soot cladding tube 318, the soot and bait rod workpiece 158 can be placed in a consolidation furnace 160 and heat treated. The heat treatment decreases the porosity of the silica soot of the soot cladding tube 318 and thereby increases the density thereof to transform the soot cladding tube 318 on the consolidation bait rod 112 (as the soot and bait rod workpiece 158) into the consolidated cladding tube 218 on the consolidation bait rod 112 (as the consolidated workpiece 106).

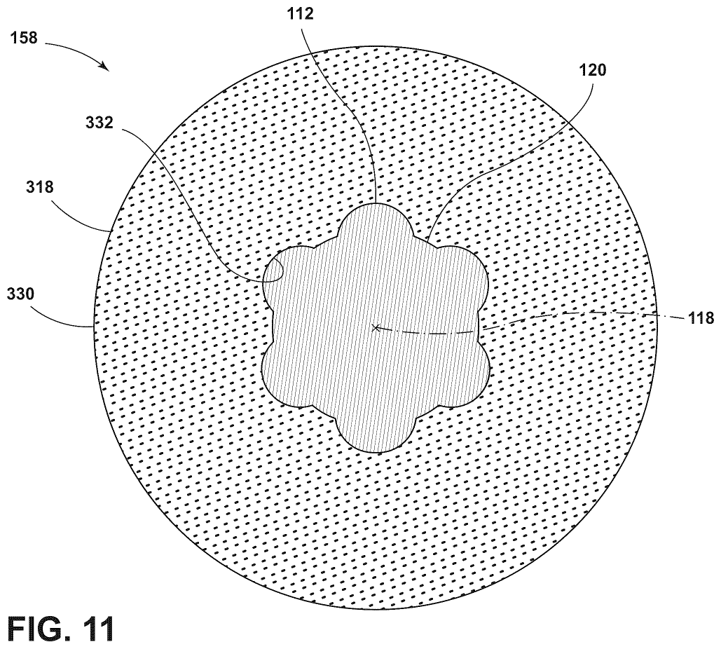

In embodiments (see FIG. 11), the soot cladding inner surface 332 contacts the consolidation rod outer surface 120 entirely azimuthally around the consolidation rod longitudinal axis 118 before the direct soot consolidating step 156. Stated another way, the soot cladding inner surface 332 conforms to the consolidation rod outer surface 120 entirely azimuthally around the consolidation rod longitudinal axis 118 before the direct soot consolidating step 156.

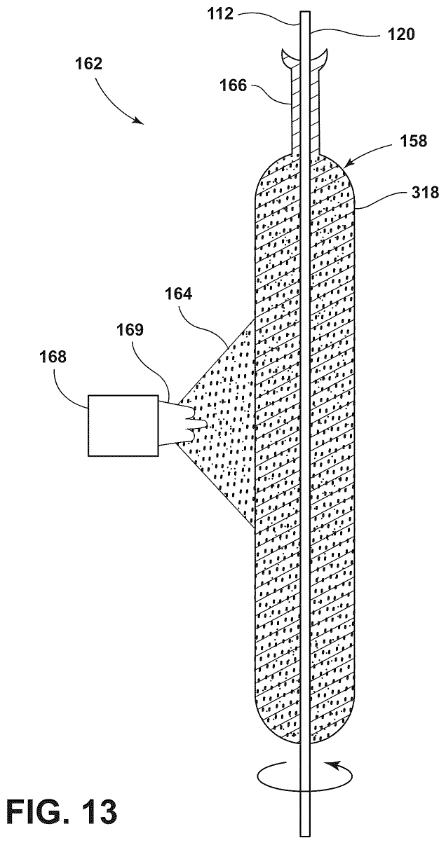

In that regard, referring additionally to FIG. 13, the first method 100 can further include a direct soot depositing step 162. The direct soot depositing step 162 occurs before the direct soot consolidating step 156. The direct soot depositing step 162 includes depositing silica soot 164 onto the consolidation rod outer surface 120 of the consolidation bait rod 112 to form the soot cladding tube 318 and thus the soot and bait rod workpiece 158. The silica soot 164 can be deposited using any one of a variety of vapor deposition processes. For example, a modified form of chemical vapor deposition (CVD) can be utilized. In this modified form of CVD, the consolidation bait rod 112 is inserted through a hollow glass handle 166 and mounted on a lathe (not illustrated). The lathe rotates and translates the consolidation bait rod 112 near a burner 168. The burner 168 produces a flame 169 that heats the consolidation bait rod 112. A gas, including source materials for the silica soot 164, is introduced into the flame. The flame causes the source materials to react and form the silica soot 164 that deposits, layer by layer, on the consolidation rod outer surface 120 of the consolidation bait rod 112. This modified form of CVD is sometimes referred to as outside vapor deposition (OVD). The reactions of the source materials in the flame are flame hydrolysis or oxidation reactions. In embodiments, the soot cladding tube 318 can have a weight that is within a range of from 0.1 kg to 10 kg. For example, the weight can be 0.1 kg, 0.5 kg, 1.0 kg, 2.0 kg, 3.0 kg, 4.0 kg, 5.0 kg, 6.0 kg, 7.0 kg, 8.0 kg, 9.0 kg, 10 kg, or within any range bound by any two of those values (e.g., from 1.0 kg to 6.0 kg, from 4.0 kg to 9.0 kg, and so on).

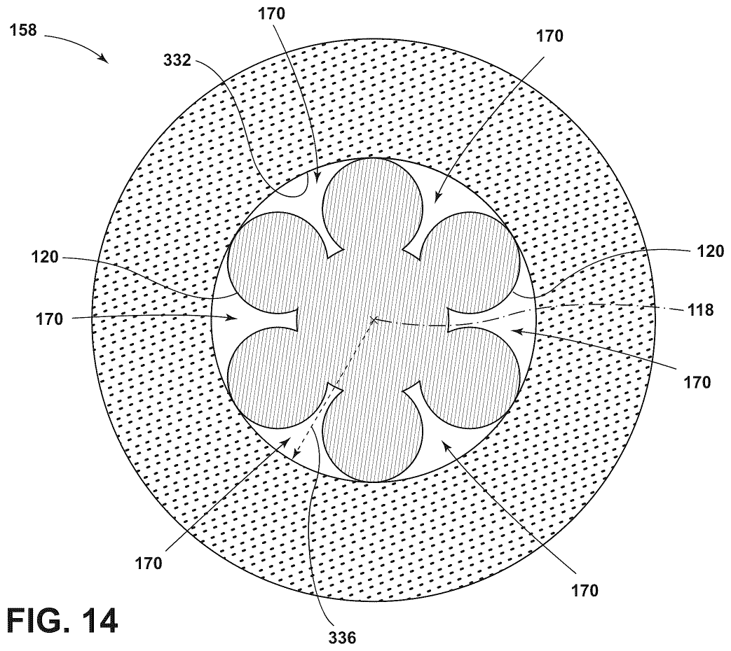

In other embodiments, referring now to FIG. 14, the soot cladding inner surface 332 of the soot and bait rod workpiece 158 is separated from the consolidation rod outer surface 120 by air gaps 170 before the direct soot consolidating step 156. The air gaps 170 are arranged azimuthally around the consolidation rod longitudinal axis 118. Stated another way, the soot cladding inner surface 332 does not conform entirely to the consolidation rod outer surface 120. For example, the soot cladding inner surface 332 can be cylindrical with a soot cladding inner radius 336 from the consolidation rod longitudinal axis 118 that is dimensioned to permit the soot cladding tube 318 to friction fit on the consolidation bait rod 112.

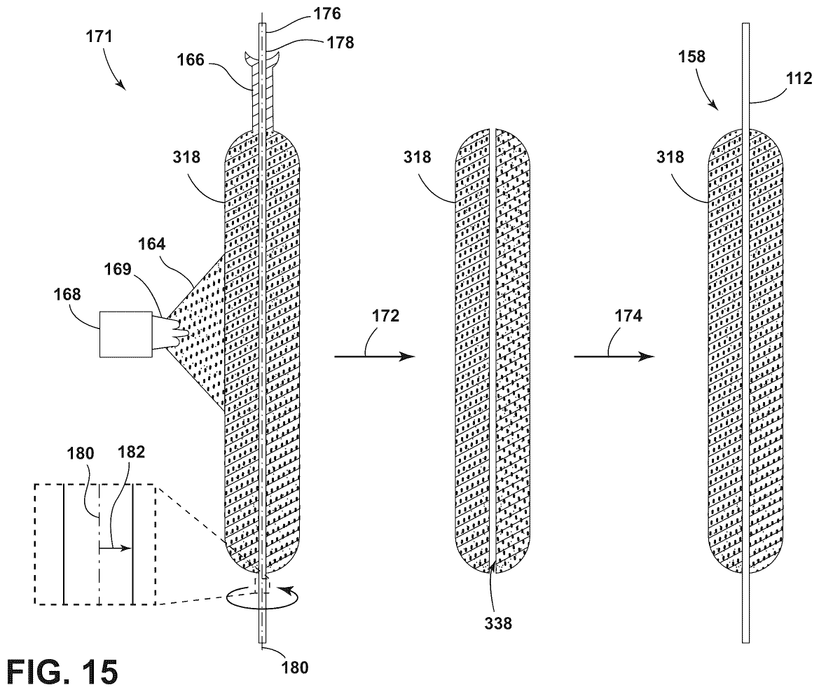

In that regard, referring additionally to FIG. 15, the first method 100 can further include an indirect soot depositing step 171, a deposition bait rod removing step 172, and a bait rod insertion step 174, all of which occur before the direct soot consolidating step 156. The indirect soot depositing step 171 includes depositing silica soot onto a deposition bait rod 176, particularly a deposition rod outer surface 178 thereof, to form the soot cladding tube 318. The deposition bait rod 176 is different that the consolidation bait rod 112. The deposition bait rod 176 includes a deposition rod longitudinal axis 180. The deposition rod outer surface 178 is at a deposition rod outer radius 182 from the deposition rod longitudinal axis 180. The deposition rod outer radius 182 is constant azimuthally around the deposition rod longitudinal axis 180. In short, the deposition rod outer surface 178, viewed cross-sectionally (not separately illustrated) orthogonal to the deposition rod longitudinal axis 180, is circular. A vapor deposition process, such as OVD, can be utilized as described above for the indirect soot depositing step 171. As a result, the soot cladding tube 318 is formed with the soot cladding interior 338. The deposition bait rod removing step 172 includes removing the deposition bait rod 176 from the soot cladding interior 338. The bait rod insertion step 174 includes thereafter inserting the consolidation bait rod 112 into the soot cladding interior 338 to form the soot and bait rod workpiece 158, which can then be subjected to the direct soot consolidating step 156 as discussed.

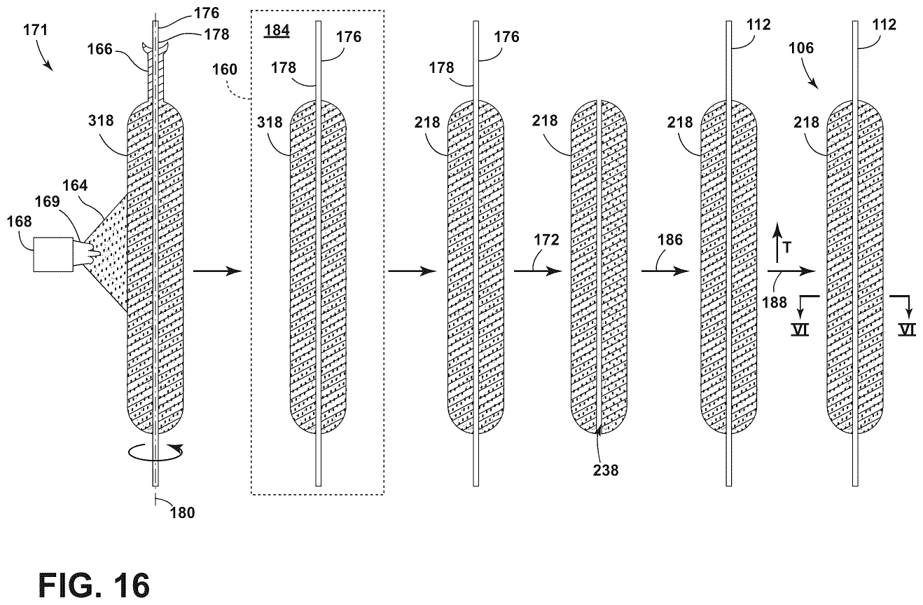

Referring now to FIG. 16, in yet another way to make the consolidated workpiece 106, the first method 100 includes the indirect soot depositing step 171, an indirect soot consolidating step 184, the deposition bait rod removing step 172, a reflow rod insertion step 186, and a reflowing step 188. The indirect soot depositing step 171 forms the soot cladding tube 318 on the deposition bait rod 176, as described above.

The indirect soot consolidating step 184 includes consolidating the soot cladding tube 318 around the deposition rod outer surface 178 to form the consolidated cladding tube 218. The silica of the soot cladding tube 318 is consolidated, such as in the consolidation furnace 160, to form the consolidated cladding tube 218.

The deposition bait rod removing step 172 includes removing the deposition bait rod 176 from the consolidated cladding interior 238.

The reflow rod insertion step 186 includes inserting the consolidation bait rod 112 into the consolidated cladding interior 238.

The reflowing step 188 includes thermally treating the consolidated cladding tube 218 with the consolidation bait rod 112 therein so that the consolidated cladding tube 218 flows to conform the consolidated cladding inner surface 232 around the consolidation rod outer surface 120. The thermal treatment is at a temperature greater than the softening point of the consolidated cladding tube 218. The reflowing step 188 forms the consolidated workpiece 106, which can then be subjected to the consolidated workpiece presenting step 102 described above.

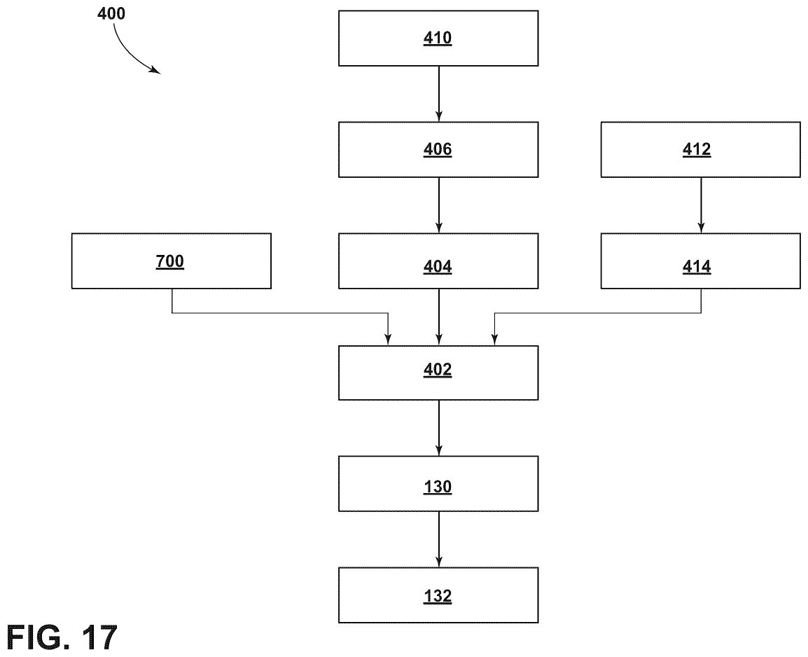

Referring now to FIG. 17, a second method 400 of manufacturing the hollow core optical fiber 10 is herein presented. The second method 400 includes a consolidated tube presenting step 402 and the capillary tube coupling step 130. The consolidated tube presenting step 402 includes presenting the consolidated cladding tube 218. As will be explained, the consolidated cladding tube 218 can be formed without utilizing the consolidation bait rod 112, which was a focus of the first method 100. The capillary tube coupling step 130 is as described above as well, with the preform capillary tubes 220 being coupled to the consolidated cladding inner surface 232 within the consolidated cladding recesses 240 thus creating the optical fiber preform 210.

In embodiments, the second method 400 further includes the drawing step 132. The drawing step 132 includes drawing the hollow core optical fiber 10 from the optical fiber preform 210. The drawing step 132 is the same as that described for the first method 100.

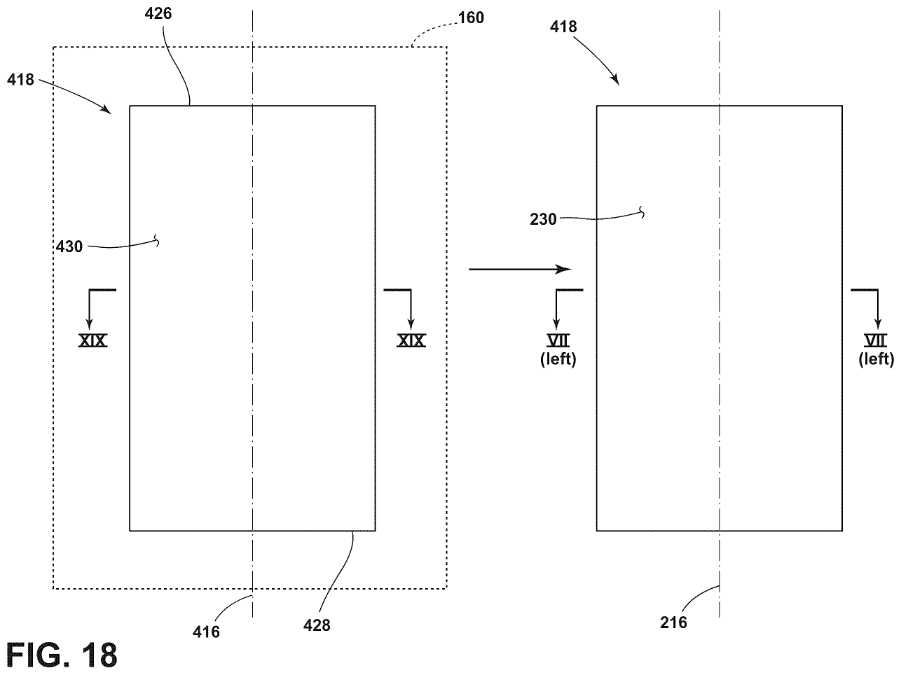

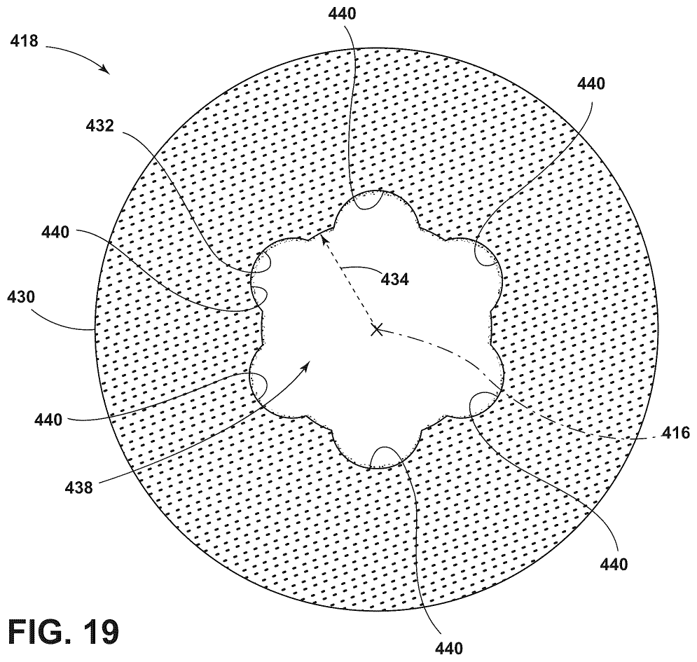

In embodiments, referring additionally to FIGS. 18 and 19, the second method 400 further includes a recessed soot cladding consolidating step 404. The recessed soot cladding consolidating step 404 occurs before the consolidated tube presenting step 402. The recessed soot cladding consolidating step 404 includes consolidating a recessed soot cladding tube 418 to form the consolidated cladding tube 218. The recessed soot cladding tube 418 is analogous to the consolidated cladding tube 218 but includes silica soot that has not yet been consolidated. The recessed soot cladding tube 418 thus includes a recessed soot cladding first end 426, a recessed soot cladding second end 428, a recessed soot cladding longitudinal axis 416, a recessed soot cladding outer surface 430, and a recessed soot cladding inner surface 432. The recessed soot cladding outer surface 430 is at a recessed soot cladding outer radius 434 from the recessed soot cladding longitudinal axis 416. The recessed soot cladding inner surface 432 defines a recessed soot cladding interior 438. The recessed soot cladding inner surface 432 includes recessed soot cladding recesses 440 positioned around the recessed soot cladding longitudinal axis 416. The recessed soot cladding recesses 440 extend from the recessed soot cladding first end 426 to the recessed soot cladding second end 428. The recessed soot cladding tube 418 can be consolidated in the consolidating furnace 160 as described above.

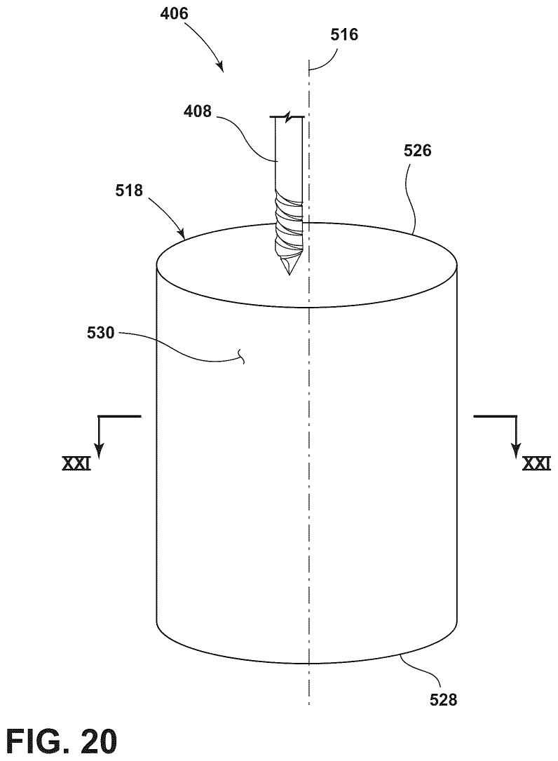

Referring now to FIG. 20, in embodiments, the second method 400 further includes a soot recess machining step 406. The soot recess machining step 406 occurs before the recessed soot cladding consolidating step 404. The soot recess machining step 406 includes machining the recessed soot cladding recesses 440 into a soot blank tube 518 to form the recessed soot cladding tube 418. The soot blank tube 518 includes a soot blank first end 526 that becomes the recessed soot cladding first end 426 of the recessed soot cladding tube 418, a soot blank second end 528 that becomes the recessed soot cladding second end 428, a soot blank longitudinal axis 516 that becomes the recessed soot cladding longitudinal axis 416, a soot blank outer surface 530 that becomes the recessed soot cladding outer surface 430, and a soot blank inner surface 532 that is cylindrical and at a soot blank inner radius 536 from the soot blank longitudinal axis 516. The soot blank inner radius 536 is smaller than the recessed soot cladding inner radius 336. The soot recess machining step 406 removes silica soot from the soot blank tube 518 to form the soot cladding inner surface 332. The soot recess machining step 406 can include drilling holes into (or otherwise drilling out silica from) the soot blank tube 518 to remove the silica soot necessary to form the recessed soot cladding recesses 440. A drill bit 408 can be utilized with dimensions appropriate to form the recessed soot cladding recesses 440 at the soot cladding inner surface 332. In one embodiment, a plurality of holes that are spaced apart azimuthally are drilled. The holes are of the same or similar diameter and have centers at a common radial distance from soot blank longitudinal axis 516. A further drilling step is performed to form a hole centered at the soot blank longitudinal axis 516 with a radius equal to the common radial distance to remove portions of the soot blank tube 518 within the common radial distance to form the recessed soot cladding recesses 440. The soot blank tube 518 can be formed by a vapor depositing silica soot onto a deposition bait rod 176 that is cylindrical and then removing the deposition bait rod 176.

In embodiments, the second method 400 can further include a soot blank forming step 410. The soot blank forming step 410 occurs before the soot recess machining step 406. The soot blank forming step 410 can include vapor depositing silica soot on the deposition bait rod 176 to form the soot blank tube 518. The silica soot can be deposited on the deposition bait rod 176, such as one that is cylindrical, using a vapor deposition method as described above.

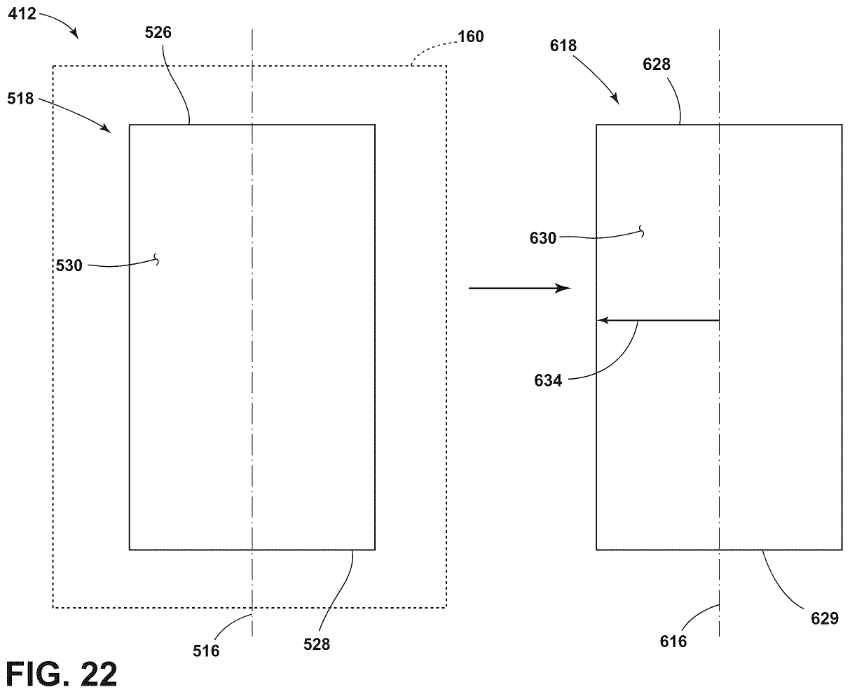

Referring additionally to FIG. 22, after the soot blank forming step 410, the second method 400 can further include a soot blank consolidating step 412. The soot blank consolidating step 412 includes consolidating the soot blank tube 518. The soot blank consolidating step 412 can be performed in a consolidation furnace 160, as described above. The consolidation of the soot blank tube 518 decreases the porosity of the silica. The soot blank consolidating step 412 transforms the soot blank tube 518 into a consolidated blank tube 618. The consolidated blank tube 618 is analogous to the soot blank tube 518. The consolidated blank tube 618 includes a consolidated blank longitudinal axis 616, a consolidated blank first end 628, a consolidated blank second end 629, and a consolidated blank outer surface 630. The consolidated blank outer surface 630 is at a consolidated blank outer radius 634 from the consolidated blank longitudinal axis 616. The consolidated blank outer radius 634 may be substantially constant azimuthally around the consolidated blank longitudinal axis 616. The soot blank consolidating step 412 can be performed with the deposition bait rod 176 still within the soot blank tube 518 but need not be.

After the soot blank consolidating step 412, the second method 400 can further include a consolidated recess machining step 414. The consolidated recess machining step 414 can be visualized as analogous to the soot recess machining step 406 illustrated at FIG. 20 without the need for a separate illustration. The consolidated recess machining step 414 includes machining the consolidated cladding recesses 240 into the consolidated blank tube 618 to form the consolidated cladding inner surface 232 of the consolidated cladding tube 218 with the consolidated cladding recesses 240. The consolidated recess machining step 414 can include drilling holes into (or otherwise drilling silica out of) the consolidated blank tube 618 to form the consolidated cladding inner surface 232 with the consolidated cladding recesses 240. A drill bit 408 can be utilized with dimensions appropriate to form the consolidated cladding recesses 240.

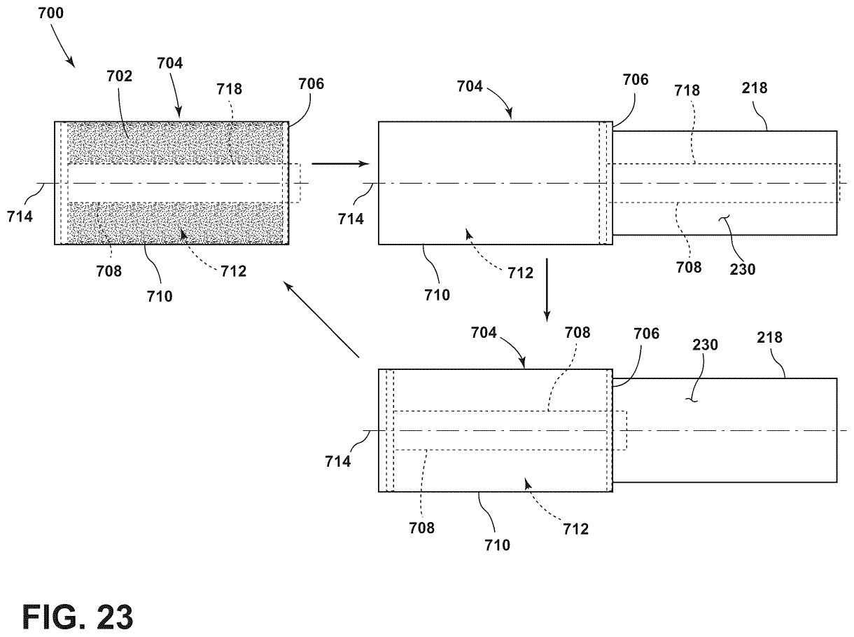

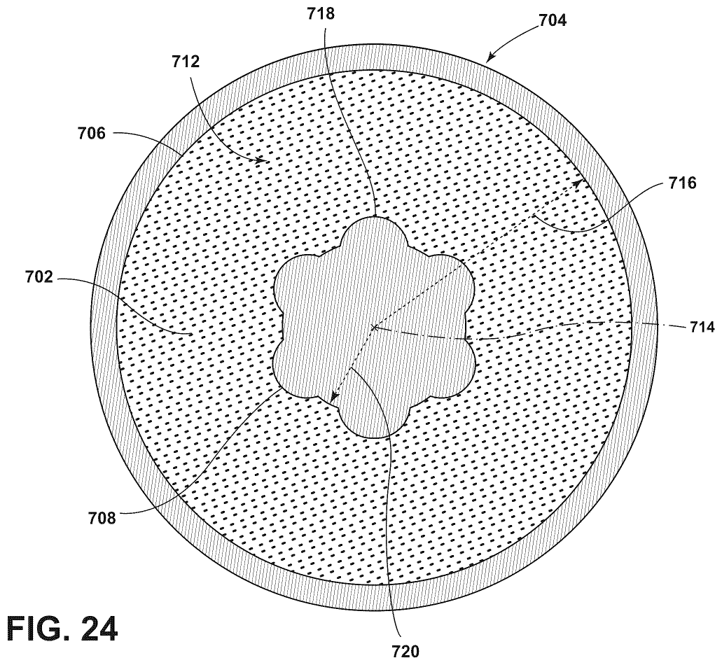

Referring now to FIGS. 23 and 24, in embodiments, the second method 400 includes an extruding step 700 to form the consolidated cladding tube 218. The extruding step 700 includes extruding molten or softened glass 702 with an extrusion die 704 to form the consolidated cladding tube 218. In general, the extrusion die 704 establishes the consolidated cladding outer surface 230 and the consolidated cladding inner surface 232 with the consolidated cladding recesses 240.

In embodiments, the extrusion die 704 includes an outer extrusion aperture 706, an inner extrusion rod 708, an injection container 710 defining an injection chamber 712, and an extrusion longitudinal axis 714. The extrusion longitudinal axis 714 extends through outer extrusion aperture 706, the inner extrusion rod 708, and the injection chamber 712. The outer extrusion aperture 706 is at an outer extrusion radius 716 from the extrusion longitudinal axis 714. The inner extrusion rod 708 includes an extrusion rod outer surface 718. The extrusion rod outer surface 718 is at an extrusion rod outer radius 720 from the extrusion longitudinal axis 714. The extrusion rod outer radius 720 varies azimuthally around the extrusion longitudinal axis 714. The extrusion rod outer surface 718 is dimensioned to generate the consolidated cladding recesses 240 of the consolidated cladding tube 218. The extrusion rod outer surface 718 is analogous to the consolidation rod outer surface 120.

In embodiments, during the extruding step 700, the molten glass 702 is injected into the injection chamber 712 of the injection container 710. The inner extrusion rod 708 is likewise disposed at least partially within the injection chamber 712. The molten glass 702 can fill the injection chamber 712 and be disposed around the inner extrusion rod 708, contacting the extrusion rod outer surface 718. The molten glass 702 with the inner extrusion rod 708 is then pushed out of the injection container 710 simultaneously through the outer extrusion aperture 706. The molten glass 702 is disposed radially from the extrusion longitudinal axis 714 between the inner extrusion rod 708 and the outer extrusion aperture 706. Pushing the molten glass 702 through the outer extrusion aperture 706 defines the consolidated cladding outer surface 230. When the molten glass 702 is sufficiently solidified to hold its shape, the inner extrusion rod 708 is retracted from the sufficiently solidified glass and returned back through the outer extrusion aperture 706 to the injection chamber 712, leaving the consolidated cladding tube 218. The inner extrusion rod 708 thus defines the consolidated cladding inner surface 232 with the consolidated cladding recesses 240 and the consolidated cladding tube 218 and is thus formed.

The first method 100 and the second method 400 of the present disclosure address the problems identified in the Background, among others, in a variety of ways. The optical fiber preform 210 manufactured by the first method 100 and the second method 400 includes the preform capillary tubes 220 fused to the consolidated cladding recesses 240. The consolidated cladding recesses 240 facilitate maintaining the preform capillary tubes 220 in their as-designed positioned during the drawing step 132 and thus facilitate maintaining the fiber primary capillaries 20 in their as-designed position for the hollow core optical fiber 10. The first method 100 and the second method 400 provide any of a variety of disclosed ways to manufacture the consolidated cladding tube 218 with the consolidated cladding recesses 240.

It will be apparent to those skilled in the art that various modifications and variations can be made without departing from the spirit or scope of the claims.

What is claimed is:

1. A method of manufacturing a hollow core optical fiber, the method comprising:
a consolidated workpiece presenting step comprising presenting a consolidated workpiece comprising
(a) a consolidation bait rod comprising: a consolidation rod first end, a consolidation rod second end, a consolidation rod longitudinal axis, and a consolidation rod outer surface at a consolidation rod outer radius that varies azimuthally around the consolidation rod longitudinal axis and
(b) a consolidated cladding tube disposed on the consolidation rod outer surface azimuthally around the consolidation rod longitudinal axis, the consolidated cladding tube comprising a consolidated cladding first end near the consolidation rod first end, a consolidated cladding second end near the consolidation rod second end, a consolidated cladding longitudinal axis, and a consolidated cladding inner surface, the consolidated cladding inner surface forming a consolidated cladding interior and comprising consolidated cladding recesses (i) positioned azimuthally around the consolidated cladding longitudinal axis and (ii) extending from the consolidated cladding first end to the consolidated cladding second end; and
a bait rod removing step comprising removing the consolidation bait rod from the consolidated cladding interior.

2. The method of claim 1, wherein the consolidation rod outer surface comprises (i) constant portions where the consolidation rod outer radius is constant as a function of azimuthal position around the consolidation rod longitudinal axis and (ii) variable portions where the consolidation rod outer radius varies as a function of position around the consolidation rod longitudinal axis.

3. The method of claim 2, wherein the consolidation rod outer surface alternates between the constant portions and the variable portions azimuthally around the consolidation rod longitudinal axis.

4. The method of claim 2, wherein the variable portions extend radially outward from the constant portions relative to the consolidation rod longitudinal axis.

5. The method of claim 2, wherein the variable portions are partially circular or partially elliptical.

6. The method of claim 1, wherein the consolidation bait rod comprises graphite, alumina, or zirconia.

7. The method of claim 1, further comprising:
a capillary tube coupling step, occurring after the bait rod removing step, comprising coupling preform capillary tubes to the consolidated cladding inner surface within the consolidated cladding recesses thus creating an optical fiber preform, each of the preform capillary tubes disposed within a different one of the consolidated cladding recesses.

8. The method of claim 7, further comprising:
a drawing step comprising drawing a hollow core optical fiber from the optical fiber preform.

9. The method of claim 1, further comprising:
a direct soot consolidating step, occurring before the consolidated workpiece presenting step, comprising consolidating a soot cladding tube that is disposed azimuthally around the consolidation rod outer surface of the consolidation bait rod to form the consolidated workpiece, the soot cladding tube comprising a soot cladding first end near the consolidation rod first end, a soot cladding second end near the second consolidation rod end, and a soot cladding inner surface defining a soot cladding interior through which the consolidation rod longitudinal axis extends.

10. The method of claim 9, wherein the soot cladding inner surface contacts the consolidation rod outer surface entirely azimuthally around the consolidation rod longitudinal axis before the direct soot consolidating step.

11. The method of claim 10, further comprising:
a direct soot depositing step, occurring before the direct soot consolidating step, comprising depositing silica soot onto the consolidation rod outer surface of the consolidation bait rod to form a soot and bait rod workpiece.

12. The method of claim 9, wherein the soot cladding inner surface is separated from the consolidation rod outer surface by air gaps arranged azimuthally around the consolidation rod longitudinal axis before the direct soot consolidating step.

13. The method of claim 12, further comprising:
an indirect soot depositing step comprising depositing silica soot onto a deposition rod outer surface of a deposition bait rod to form the soot cladding tube, the deposition bait rod further comprising a deposition rod longitudinal axis, the deposition rod outer surface at a deposition rod outer radius from the deposition rod longitudinal axis that is constant azimuthally around the deposition rod longitudinal axis;
a deposition rod removing step comprising removing the deposition bait rod from the soot cladding interior; and
a bait rod insertion step comprising inserting the consolidation bait rod into the soot layer interior,
wherein, the indirect soot depositing step, the deposition rod removing step, and the bait rod insertion step occur before the direct soot consolidating step.

14. The method of claim 1, further comprising:
an indirect soot depositing step comprising depositing silica soot onto a deposition rod outer surface of a deposition bait rod to form a soot cladding tube, the deposition bait rod further comprising a deposition rod longitudinal axis, the deposition rod outer surface at a deposition rod outer radius from the deposition rod longitudinal axis that is constant azimuthally around the deposition rod longitudinal axis;
an indirect soot consolidating step comprising consolidating the soot cladding tube around the deposition rod outer surface to form the consolidated cladding tube;
a deposition rod removing step comprising removing the deposition bait rod from the consolidated cladding interior;
a reflow rod insertion step comprising inserting the consolidation bait rod into the consolidated cladding interior; and
a reflowing step comprising thermally treating the consolidated cladding tube with the consolidation bait rod therein so that the consolidated cladding tube flows to conform the consolidated cladding inner surface around the consolidation rod outer surface, thus forming the consolidated workpiece.

15. A method of manufacturing a hollow core optical fiber, the method comprising:
a consolidated tube presenting step comprising presenting a consolidated cladding tube comprising a consolidated cladding first end, a consolidated cladding second end, a consolidated cladding longitudinal axis, and a consolidated cladding inner surface, the consolidated cladding inner surface defining a consolidated cladding interior and comprising consolidated cladding recesses (i) positioned around the consolidated cladding longitudinal axis and (ii) extending from the consolidated first end to the consolidated second end; and
a capillary tube coupling step comprising coupling preform capillary tubes to the consolidated cladding inner surface within the consolidated cladding recesses thus creating an optical fiber preform, each of the preform capillary tubes disposed within a different one of the consolidated cladding recesses.

16. The method of claim 15, further comprising:
a drawing step comprising drawing a hollow core optical fiber from the optical fiber preform.

17. The method of claim 15, further comprising:
a recessed soot cladding consolidating step comprising consolidating a recessed soot cladding tube to form the consolidated cladding tube, the recessed soot cladding tube comprising: a recessed soot cladding first end, a recessed soot cladding second end, a recessed soot cladding longitudinal axis, and a recessed soot cladding inner surface, the recessed soot cladding inner surface defining a recessed soot cladding interior and comprising recessed soot cladding recesses (i) positioned around the recessed soot cladding longitudinal axis and (ii) extending from the recessed soot cladding first end to the recessed soot cladding second end.

18. The method of claim 16, further comprising:
a soot blank forming step comprising vapor depositing silica soot on a deposition bait rod to form a soot blank tube;
a soot blank consolidating step comprising consolidating the soot blank tube to form a consolidated blank tube comprising (i) a consolidated blank longitudinal axis and (ii) a consolidated blank outer surface at a consolidated blank outer radius from the consolidated blank longitudinal axis that is substantially constant azimuthally around the consolidated blank longitudinal axis; and
a consolidated recess machining step comprising machining the consolidated cladding recesses into the consolidated blank tube to form the consolidated cladding tube.

19. The method of claim 16, further comprising:
an extruding step comprising extruding molten or softened glass with an extrusion die to form the consolidated cladding tube.

20. The method of claim 19, wherein the extrusion die comprises (i) an outer extrusion aperture that is at an outer extrusion radius from an extrusion longitudinal axis and (ii) an inner extrusion rod through which the extrusion longitudinal axis extends, the inner extrusion rod comprising an extrusion rod outer surface at an extrusion rod outer radius that varies azimuthally around the extrusion longitudinal axis, and during the extruding of the molten glass, (i) the molten glass and the inner extrusion rod are pushed through the outer extrusion aperture, with the molten glass disposed radially between the inner extrusion rod and the outer extrusion aperture relative to the extrusion longitudinal axis and (ii) the inner extrusion rod is retracted back through the outer extrusion aperture leaving the workpiece.
